(19) United States
(12) Patent Application Publication
(10) Pub. No.: US 2021/0404669 A1
(43) Pub. Date: Dec. 30, 2021

(54) ORGANIC RANKINE CYCLE POWER GENERATION SYSTEM USING HEAT STORAGE TANK

(71) Applicant: YOUNG-KWANG CO.LTD., Ulsan (KR)

(72) Inventors: Chul Koo HEO, Ulsan (KR); Cheol Ki HUR, Ulsan (KR); Kyoung Su KIM, Ulsan (KR); Se Kyoung BANG, Ulsan (KR); In Ho SEO, Ulsan (KR); Sang Yun LEE, Ulsan (KR)

(73) Assignee: YOUNG-KWANG CO.LTD., Ulsan (KR)

(21) Appl. No.: 16/609,449

(22) PCT Filed: Oct. 19, 2018
(86) PCT No.: PCT/KR2018/012401

§ 371 Date: Oct. 29, 2019

(30) Foreign Application Priority Data
Jun. 19, 2018 (KR) 10-2018-0070467
Jul. 5, 2018 (KR) 10-2018-0078413

(51) Int. Cl. F24D 11/00; F24D 19/10; F02G 5/02

(52) U.S. Cl. CPC F24D 11/005; F24D 19/1015; F02G 5/02; F24D 2200/16; F24D 2220/046; F24D 2220/048; F24D 2220/08; F24D 2220/042

(57) ABSTRACT

An Organic Rankine Cycle power generation system includes: a first heat storage tank having a closed cylindrical shape and including a first internal heat exchanger therein; a second heat storage tank including a second internal heat exchanger therein; a first circulating pipe branched from a high temperature water supply pipe; a second circulation pipe branched from the high temperature water supply pipe; a first cold water supply pipe supplying cold water from the outside to the inside of the first heat storage tank; a second cold water supply pipe supplying cold water from the outside to the inside of the second heat storage tank; and an opening and closing unit selectively opening and closing the first circulation pipe and the second circulation pipe, and the first cold water supply pipe and the second cold water supply pipe.

### TECHNICAL FIELD

The present disclosure relates to an Organic Rankine Cycle power generation system using a heat storage tank, and more particularly, to an Organic Rankine Cycle power generation system using a heat storage tank, which is capable of automatically adjusting a temperature of heating water inside the heat storage tank while adjusting the pressure and a water level inside the heat storage tank by automatically adjusting a supply amount of high temperature water of which heat is exchanged with working fluid during an Organic Rankine Cycle to the heat storage tank and a supply amount of cold water supplied from the outside.

### BACKGROUND ART

Referring to the Background Art described in KR 0812496, a cogeneration system that simultaneously supplies heat energy and electric energy as a main heat source facility for collective energy supply is a high-efficiency energy technology that recovers and usefully uses waste heat inevitably generated during a process of receiving fuel, such as a gas, and generating and developing electricity in a generator, and is environmentally friendly and energy saving with 30 to 40% energy saving effect of electric power, fuel, and the like compared to a conventional power generation method. However, conventional heating and hot water pipes for general cogeneration are not practical in terms of thermodynamics and economics due to excessive deficiency of heating energy per season and a large energy loss caused by inappropriate use of a high-temperature heating medium circulating in heat exchange, and thus are unable to cope with an energy load smoothly and have a low utilization rate of waste heat.

A general conventional cogeneration system includes a plurality of heat exchangers, heat storage tanks, circulation pumps, and the like on a heating water circulation pipe in addition to a cogenerator, a boiler, a cooling tower, and a distributer to comprehensively perform electricity supply, heating, hot water supply, and the like on a source of demand for heat.

As schematically shown in FIG. 1, hot water supply is performed as heating water heated by using, as heat sources, a cogenerator 10 that generates electric power while supplying water for heating use using an exhaust gas and a waste heat recovery boiler 30 that supplements a deficient heat source circulates and passes through a hot water storage tank 40 that stores and supplies, via heat storage, heated water to a heat supply distributer 14. A cogeneration system is configured such that heating circulation water that performed the hot water supply is returned by being branched into the cogenerator 10 and the boiler 30 through a heat return distributer 15, while the heating circulation water at the side of the cogenerator 10 is supplied after passing through a cooling tower 20 and is supplied to the boiler 30 after passing through a boiler-dedicated circulation pump 31.

Heated hot water is pumped and supplied to heating and hot water supply pipes configured of a closed loop for heated hot water supply and return, by heating a low temperature direct water by using waste heat of the cogenerator. A heat supply and recovery method is realized by circulating, on a pipe, heating water of which constant temperature is maintained as heat of supplied hot water is frequently exchanged with cold water in the hot water storage tank 40 as needed, thereby performing heating and hot water supply, cooling the heating water returned after performing the heating, and supplying cooled cooling water to a cogenerator.

However, in order to adjust the heating water in which hot water and cold water are mixed in the hot water storage tank 40 to a setting temperature, an operator needs to frequently adjust supply of the hot water and the cold water, and in order to adjust the pressure inside the hot water storage tank 40 or adjust a water level of the heating water, the operator needs to frequently adjust the supply of the hot water and the cold water, and thus efficiency deteriorates.

### DESCRIPTION OF EMBODIMENTS

### Technical Problem

The present disclosure is directed to providing an Organic Rankine Cycle power generation system using a heat storage tank, wherein a control unit adjusts supply amounts of high temperature water and cold water supplied to a district heating heat storage tank by selectively opening or closing a plurality of opening and closing valves to adjust a temperature of heating water in the heat storage tank and the pressure and a water level inside the heat storage tank, and use, as heating water, the cold water of which heat is exchanged with the high temperature water inside the heat storage tank, thereby increasing energy efficiency.

### Solution to Problem

According to an aspect of the present disclosure, an Organic Rankine Cycle power generation system using a heat storage tank for accumulating heat remaining after heat exchange in an Organic Rankine Cycle, the Organic Rankine Cycle power generation system includes: a first heat storage tank having a closed cylindrical shape and including a first internal heat exchanger therein; a second heat storage tank spaced apart from the first heat storage tank, having a closed cylindrical shape, and including a second internal heat exchanger therein; a first circulating pipe branched from a high temperature water supply pipe in which high temperature water supplied from a district heating system is transferred after heat exchange with working fluid in an Organic Rankine Cycle, supplying the high temperature water to the first internal heat exchanger of the first heat storage tank, and circulating hot water of which heat is exchanged in the first internal heat exchanger to a heat exchanger; a second circulation pipe branched from the high temperature water supply pipe, supplying the high temperature water to the second internal heat exchanger of the second heat storage tank, and circulating hot water of which heat is exchanged in the second internal heat exchanger to the heat exchanger; a first cold water supply pipe supplying cold water from the outside to the inside of the first heat storage tank; a second cold water supply pipe supplying cold water from the outside to the inside of the second heat storage tank; and an opening and closing unit selectively opening and closing the first circulation pipe and the second circulation pipe, and the first cold water supply pipe and the second cold water supply pipe, wherein the heat exchanger exchanges heat between the high temperature water supplied from the Organic Rankine Cycle through the high temperature water supply pipe and the hot water supplied through the first circulation pipe and the second circulation pipe.

The opening and closing unit may include: a first high temperature water opening and closing valve provided on the first circulation pipe and opening or closing the first circulation pipe such that the high temperature water is selectively supplied from the high temperature water supply pipe to the first circulation pipe; a second high temperature water opening and closing valve provided on the second circulation pipe and opening or closing the second circulation pipe such that the high temperature water is selectively supplied from the high temperature water supply pipe to the second circulation pipe; a first cold water opening and closing valve provided on the first cold water supply pipe and opening or closing the first cold water supply pipe such that the cold water is selectively supplied from the outside to the first heat storage tank; and a second cold water opening and closing valve provided on the second cold water supply pipe and opening or closing the second cold water supply pipe such that the cold water is selectively supplied from the outside to the second heat storage tank.

The Organic Rankine Cycle power generation system may further include a sensor unit provided at the first heat storage tank and the second heat storage tank to measure pressure in the first and second heat storage tanks, water levels in the first and second heat storage tanks, and temperatures of the heating water in the first and second heat storage tanks.

The Organic Rankine Cycle power generation system may further includes a control unit to which pressure data, water level data, and temperature data measured by the sensor unit are transmitted and selectively opens or closes the first high temperature water opening and closing valve, the second high temperature water opening and closing valve, the first cold water opening and closing valve, and the second cold water opening and closing valve to adjust the pressure, the water levels, and the temperatures in the first and second heat storage tanks according to pre-set pressure, water level, and temperature conditions.

The Organic Rankine Cycle power generation system may further include a fixing frame unit that supports and fixes the first and second heat storage tanks, which are spaced apart from each other, from the bottom.

The sensor unit may include: a pressure sensor measuring the pressure in the first and second heat storage tanks; a water level sensor measuring the water levels in the first and second heat storage tanks; and a temperature sensor measuring the temperatures in the first and second heat storage tanks, wherein the water level sensor may include: an upper water level sensor provided at an upper portion of the first and second heat storage tanks; and a lower water level sensor provided at a lower portion of the first and second heat storage tanks.

The fixing frame unit may include: a pallet member supporting the first and second heat storage tanks from the bottom; and a fixing member fixing the pallet member and the first and second heat storage tanks in a rectangular shape, wherein the bottom of the fixing member may have a lattice structure.

### Advantageous Effects of Disclosure

In an Organic Rankine Cycle power generation system using a heat storage tank according to the present disclosure, a control unit selectively controls opening and closing of a plurality of opening and closing valves provided in a circulation pipe and a cold water supply pipe, which supply high temperature water and cold water to a heat storage tank, to adjust a temperature of heating water in the heat storage tank and the pressure and a water level inside the heat storage tank, and use, as heating water, the cold water of which heat is exchanged with the high temperature water inside the heat storage tank, thereby increasing energy efficiency.

### BRIEF DESCRIPTION OF DRAWINGS

FIG. 1 is a diagram schematically illustrating a configuration of a cogeneration system of related art.

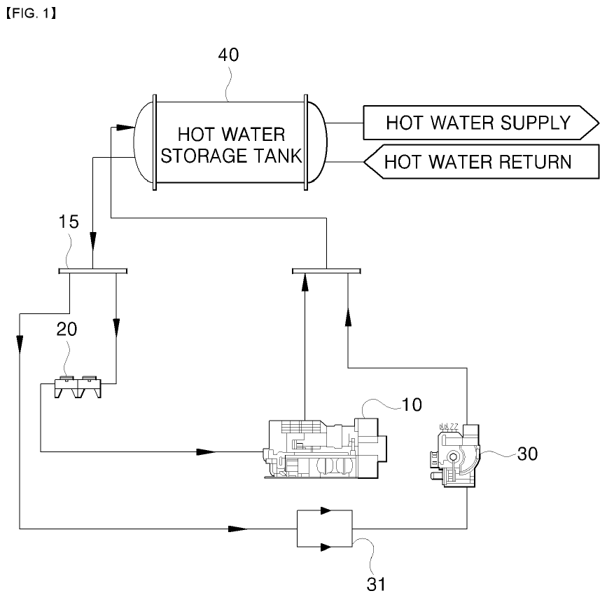

FIG. 2 is a diagram schematically illustrating a configuration of a heat storage tank of an Organic Rankine Cycle power generation system according to an embodiment of the present disclosure.

FIG. 3 is a diagram schematically illustrating a configuration of a modified heat storage tank.

FIG. 4 is a diagram illustrating a state in which a first heat storage tank and a second heat storage tank are fixed to a fixing frame unit.

### BEST MODE

Hereinafter, the present disclosure will be described more fully with reference to the accompanying drawings, in which exemplary embodiments of the present disclosure are shown. The terms or words used herein must not be interpreted in their common or dictionary definitions, but must be interpreted in the meanings and concept corresponding to the aspect of the present disclosure, based on the principle that the inventor(s) can suitably define the concept of terms in order to describe the present disclosure in the best manner.

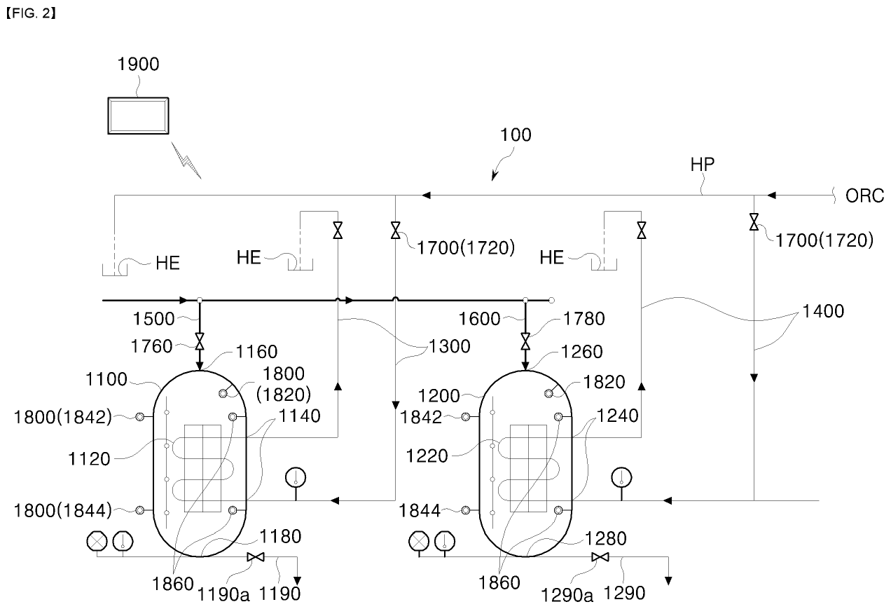

Referring to FIGS. 2 through 4, an Organic Rankine Cycle power generation system 100 using a heat storage tank, according to an embodiment of the present disclosure, is for accumulating heat remaining after heat exchange in an Organic Rankine Cycle, includes a first heat storage tank 1100, a second heat storage tank 1200, a first circulation pipe 1300, a second circulation pipe 1400, a first cold water supply pipe 1500, a second cold water supply pipe 1600, and an opening and closing unit 1700, and may further include a sensor unit 1800, a control unit 1900, and a fixing frame unit 2000.

The first heat storage tank 1100 and the second heat storage tank 1200 may have closed cylindrical shapes, be spaced apart from each other, and respectively include a first internal heat exchanger 1120 and a second internal heat exchanger 1220 therein.

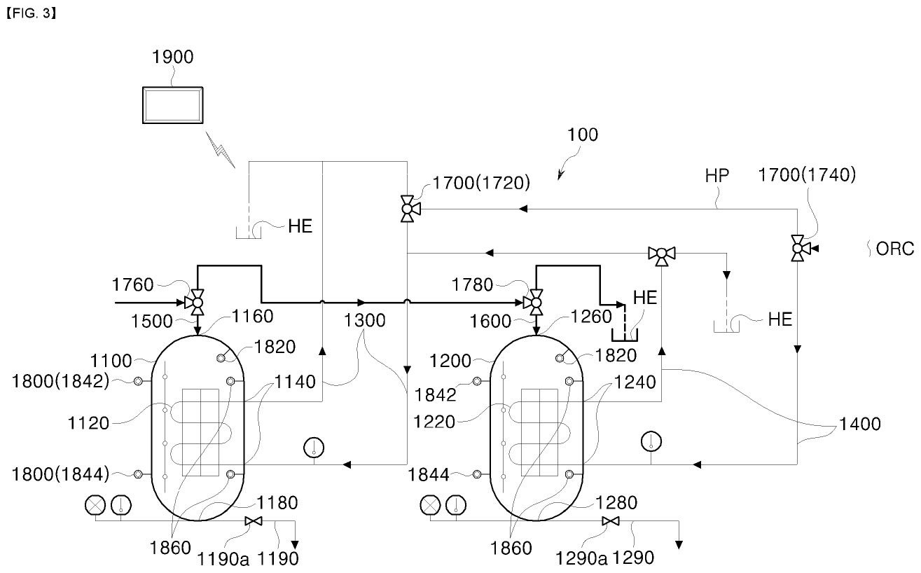

Referring to FIGS. 2 and 3, the first heat storage tank 1100 is provided with a first through hole portion 1140 to which the first circulation pipe 1300 described later is connected, a first connection hole 1160 to which the first cold water supply pipe 1500 described later is connected, and a first discharge hole 1180 discharging heating water in the first heat storage tank 1100.

The first through hole portions 1140 are vertically spaced apart from each other at one side surface of the first heat storage tank 1100, and communicate with the first internal heat exchanger 1120 provided inside the first heat storage tank 1100.

High temperature water supplied into the first heat storage tank 1100 through the bottom of the first through hole portion 1140 passes through the first internal heat exchanger 1120 and then discharged to the outside of the first heat storage tank 1100 through the top of the first through hole portion 1140.

The first internal heat exchanger 1120 may have a shape overlappingly circulating inside the first heat storage tank 1100 by being bent in a multi-stage manner inside the first heat storage tank 1100, thereby increasing a heat exchange efficiency.

The first connection hole 1160 may be formed at the top of the first heat storage tank 1100, and the first discharge hole 1180 may be formed at the bottom of the first heat storage tank 1100. Although only the first heat storage tank 1100 and the second heat storage tank 1200 are illustrated to be provided, the present disclosure is not limited thereto and the number of heat storage tanks may be increased to increase an energy efficiency.

The first circulation pipe 1300 connected to the first through hole portion 1140 of the first heat storage tank 1100 is branched from a high temperature water supply pipe HP, in which high temperature water supplied from a district heating system is transferred after heat exchange with working fluid in an Organic Rankine Cycle ORC, to supply the high temperature water to the first internal heat exchanger 1120, and the high temperature water transferred to the high temperature water supply pipe HP is supplied to a heat exchanger HE.

Hot water transferred to the first circulation pipe 1300 after heat exchange in the first internal heat exchanger 1120 of the first heat storage tank 1100 is also transferred to the heat exchanger HE and then exchanges heat with the high temperature water in the heat exchanger HE.

The second circulation pipe 1400 that supplies the high temperature water to the second internal heat exchanger 1220 of the second heat storage tank 1200 is also branched from the high temperature water supply pipe HP, and the hot water transferred to the second circulation pipe 1400 after heat exchange in the second internal heat exchanger 1220 is also transferred to the heat exchanger HE and then exchanges heat with the high temperature water in the heat exchanger HE.

Like the first heat storage tank 1100, the second heat storage tank 1200 may also include a second through hole portion 1240 to which the second circulation pipe 1400 is connected, a second connection hole 1260 to which the second cold water supply pipe 1600 described later is connected, and a second discharge hole 1280 discharging heating water inside the second heat storage tank 1200.

The heating water inside the first heat storage tank 1100 and the second heat storage tank 1200 is discharged to the first discharge hole 1180 and the second discharge hole 1280, and moving pipe opening and closing valves 1190a and 1290a that selectively open or close a first moving pipe 1190 and a second moving pipe 1290 are provided on the first moving pipe 1190 through which the heating water discharged through the first discharge hole 1180 moves and the second moving pipe 1290 through which the heating water discharged through the second discharge hole 1280 moves. The moving pipe opening and closing valves 1190a and 1290a may be selectively opened or closed by the control unit 1900 described later.

The first heat storage tank 1100 and the second heat storage tank 1200 are respectively connected to the first cold water supply pipe 1500 and the second cold water supply pipe 1600, and thus cold water supplied from the outside is supplied into the first heat storage tank 1100 and the second heat storage tank 1200. The first cold water supply pipe 1500 is connected to the first connection hole 1160 to supply the cold water into the first heat storage tank 1100, and the second cold water supply pipe 1600 is connected to the second connection hole 1260 to supply the cold water into the second heat storage tank 1200. The cold water supplied into the first heat storage tank 1100 and the second heat storage tank 1200 becomes the heating water by exchanging heat with the high temperature water in the first internal heat exchanger 1120 and the second internal heat exchanger 1220, and the heating water is discharged to the outside through the first discharge hole 1180 and the second discharge hole 1280.

The first circulation pipe 1300 and the second circulation pipe 1400 are respectively provided with a first high temperature water opening and closing valve 1720 and a second high temperature water opening and closing valve 1740, and the first high temperature water opening and closing valve 1720 and the second high temperature water opening and closing valve 1740 selectively supply the high temperature water from the high temperature water supply pipe HP to the first circulation pipe 1300 and the second circulation pipe 1400.

The opening and closing unit 1700 is provided on the first and second circulation pipes 1300 and 1400 and the first and second cold water supply pipes 1500 and 1600, and the opening and closing unit 1700 selectively opens or closes the first and second circulation pipes 1300 and 1400 and the first and second cold water supply pipes 1500 and 1600.

The opening and closing unit 1700 includes the first high temperature water opening and closing valve 1720, the second high temperature water opening and closing valve 1740, a first cold water opening and closing valve 1760, and a second cold water opening and closing valve 1780. The first high temperature water opening and closing valve 1720 and the second high temperature water opening and closing valve 1740 are respectively provided at the first circulation pipe 1300 and the second circulation pipe 1400, and the first and second high temperature water opening and closing valves 1720 and 1740 selectively supply the high temperature water from the high temperature water supply pipe HP to the first and second circulation pipes 1300 and 1400.

The first and second high temperature water opening and closing valves 1720 and 1740 may be 2-way valves (see FIG. 2) or 3-way valves (see FIG. 3). When the first and second high temperature water opening and closing valves 1720 and 1740 are used as 2-way valves, a configuration of a system is simple, and when the first and second high temperature water opening and closing valves 1720 and 1740 are used as 3-way valves, the configuration of the system is somewhat complicated, but the first and second heat storage tanks 1100 and 1200 are able to be individually controlled or associatively controlled.

The first cold water opening and closing valve 1760 and the second cold water opening and closing valve 1780 are respectively provided at the first cold water supply pipe 1500 and the second cold water supply pipe 1600, and open or close the first cold water supply pipe 1500 and the second cold water supply pipe 1600 such that the cold water is selectively supplied to the first heat storage tank 1100 and the second heat storage tank 1200. The first and second high temperature water opening and closing valves 1720 and 1740, and the first and second cold water opening and closing valves 1760 and 1780 are ordinary valves, and thus details thereof are not provided.

The sensor unit 1800 is provided at the first heat storage tank 1100 and the second heat storage tank 1200, and measures the pressure and a water level in the first and second heat storage tanks 1100 and 1200, and measures the temperature of the heating water in the first and second heat storage tanks 1100 and 1200.

The sensor unit 1800 includes a pressure sensor 1820, a water level sensor 1840, and a temperature sensor 1860. The pressure sensor 1820 is provided at the first and second heat storage tanks 1100 and 1200 and measures the pressure in the first and second heat storage tanks 1100 and 1200.

The water level sensor 1840 includes an upper water level sensor 1842 and a lower water level sensor 1844, which are respectively provided at an upper portion and a lower portion of the first and second heat storage tanks 1100 and 1200 to measure a water level of the heating water in the first and second heat storage tanks 1100 and 1200.

The temperature sensor 1860 measures the temperature of the heating water in the first and second heat storage tanks 1100 and 1200, and like the water level sensor 1840, may be provided respectively at an upper portion and a lower portion of the first and second heat storage tanks 1100 and 1200.

When the temperature sensors 1860 are spaced apart from each other at the upper portion and the lower portion of the first and second heat storage tanks 1100 and 1200, the temperature inside the first and second heat storage tanks 1100 and 1200 may be further accurately measured and a temperature difference between the upper portion and the lower portion inside the first and second heat storage tanks 1100 and 1200 may be identified.

Pressure data, water level data, and temperature data measured by the sensor unit 1800 are transmitted to the control unit 1900, and the control unit 1900 may selectively open or close the first and second high temperature water opening and closing valves 1720 and 1740 and the first and second cold water opening and closing valves 1760 and 1780 to adjust the pressure, the water level, and the temperature in the first and second heat storage tanks 1100 and 1200.

Pressure, water level, and temperature conditions in the first and second heat storage tanks 1100 and 1200 are pre-input to the control unit 1900, and the control unit 1900 controls the amounts of high temperature water and cold water supplied to the first and second heat storage tanks 1100 and 1200 based on the pre-input pressure, water level, and temperature conditions by selectively opening or closing the first and second high temperature water opening and closing valves 1720 and 1740 and the first and second cold water opening and closing valves 1740 and 1760.

When the pressure in the first and second heat storage tanks 1100 and 1200 is higher than set pressure, the control unit 1900 closes the first and second high temperature water opening and closing valves 1720 and 1740 provided at the first and second circulation pipes 1300 and 1400 to block the high temperature water supplied into the first and second heat storage tanks 1100 and 1200, thereby decreasing the pressure in the first and second heat storage tanks 1100 and 1200.

The control unit 1900 controls the water level in the first and second heat storage tanks 1100 and 1200 by selectively opening or closing the first and second cold water opening and closing valves 1760 and 1780, and when the water level is low, increases the water level by opening the first and second cold water opening and closing valves 1760 and 1780 to supply the cold water and when the water level is high, blocks the cold water from being supplied by closing the first and second cold water opening and closing valves 1760 and 1780.

When the temperature of the heating water in the first and second heat storage tanks 1100 and 1200 is high, the control unit 1900 decreases the temperature of the heating water by opening the first and second cold water opening and closing valves 1760 and 1780 to supply the cold water into the first and second heat storage tanks 1100 and 1200, and when the temperature of the heating water is low, the control unit 1900 increases the temperature of the heating water by opening the first and second high temperature water opening and closing valves 1720 and 1740 to supply the high temperature water to the first and second internal heat exchangers 1120 and 1220.

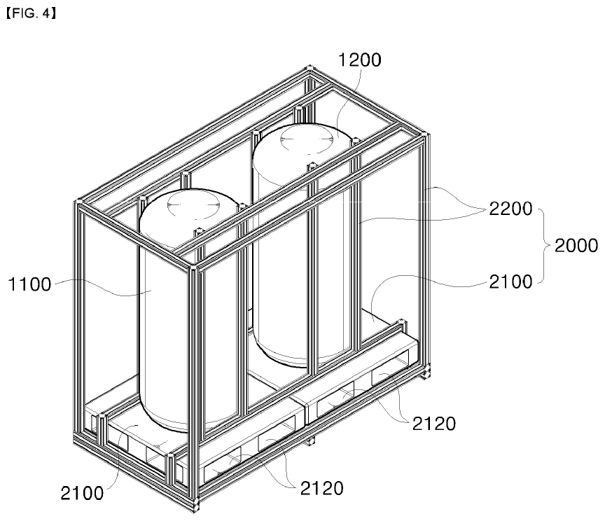

Referring to FIG. 4, the first and second heat storage tanks 1100 and 1200, which are spaced apart from each other, may be supported and fixed by the fixing frame unit 2000. The fixing frame unit 2000 includes a pallet member 2100 and a fixing member 2200, and the first and second heat storage tanks 1100 and 1200 are provided at the top of the pallet member 2100. The fixing member 2200 has a rectangular shape and fixes the pallet member 2100 and the first and second heat storage tanks 1100 and 1200 provided at the top of the pallet member 2100. The pallet member 2100, the first heat storage tank 1100, and the second heat storage tank 1200 are all fixed by the fixing member 2200, and the bottom of the fixing member 2200 may have a lattice structure to withstand the load of the first and second heat storage tanks 1100 and 1200. The pallet member 2100 may include an insertion hole 2120 into which a fork of a forklift is inserted.

The heat exchanger HE exchanges heat of the high temperature water supplied through the high temperature water supply pipe HP from the Organic Rankine Cycle ORC and the hot water supplied through the first and second circulation pipes 1300 and 1400 again to increase the energy efficiency.

Accordingly, the control unit 1900 selectively controls opening and closing of a plurality of opening and closing valves provided at the first and second circulation valves 1300 and 1400 and the first and second cold water supply pipes 1500 and 1600, which supply the high temperature water and the cold water to the first and second heat storage tanks 1100 and 1200, thereby adjusting the temperature of the heating water in the first and second heat storage tanks 1100 and 1200 and the pressure and water level in the first and second heat storage tanks 1100 and 1200 and using, as the heating water, the cold water of which the heat is exchanged with the high temperature water in the first and second heat storage tanks 1100 and 1200, and thus the energy efficiency may be increased.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

### INDUSTRIAL APPLICABILITY

The present disclosure may be used in an Organic Rankine Cycle power generation system using a heat storage tank.

1. An Organic Rankine Cycle power generation system using a heat storage tank for accumulating heat remaining after heat exchange in an Organic Rankine Cycle, the Organic Rankine Cycle power generation system comprising:
a first heat storage tank having a closed cylindrical shape and comprising a first internal heat exchanger therein;
a second heat storage tank spaced apart from the first heat storage tank, having a closed cylindrical shape, and comprising a second internal heat exchanger therein;
a first circulating pipe branched from a high temperature water supply pipe in which high temperature water supplied from a district heating system is transferred after heat exchange with working fluid in an Organic Rankine Cycle, supplying the high temperature water to the first internal heat exchanger of the first heat storage tank, and circulating hot water of which heat is exchanged in the first internal heat exchanger to a heat exchanger;
a second circulation pipe branched from the high temperature water supply pipe, supplying the high temperature water to the second internal heat exchanger of the second heat storage tank, and circulating hot water of which heat is exchanged in the second internal heat exchanger to the heat exchanger;
a first cold water supply pipe supplying cold water from the outside to the inside of the first heat storage tank;
a second cold water supply pipe supplying cold water from the outside to the inside of the second heat storage tank; and
an opening and closing unit selectively opening and closing the first circulation pipe and the second circulation pipe, and the first cold water supply pipe and the second cold water supply pipe,
wherein the heat exchanger exchanges heat between the high temperature water supplied from the Organic Rankine Cycle through the high temperature water supply pipe and the hot water supplied through the first circulation pipe and the second circulation pipe.

2. The Organic Rankine Cycle power generation system of claim 1, wherein the opening and closing unit comprises:
a first high temperature water opening and closing valve provided on the first circulation pipe and opening or closing the first circulation pipe such that the high temperature water is selectively supplied from the high temperature water supply pipe to the first circulation pipe;
a second high temperature water opening and closing valve provided on the second circulation pipe and opening or closing the second circulation pipe such that the high temperature water is selectively supplied from the high temperature water supply pipe to the second circulation pipe;
a first cold water opening and closing valve provided on the first cold water supply pipe and opening or closing the first cold water supply pipe such that the cold water is selectively supplied from the outside to the first heat storage tank; and
a second cold water opening and closing valve provided on the second cold water supply pipe and opening or closing the second cold water supply pipe such that the cold water is selectively supplied from the outside to the second heat storage tank.

3. The Organic Rankine Cycle power generation system of claim 1, further comprising a sensor unit provided at the first heat storage tank and the second heat storage tank to measure pressure in the first and second heat storage tanks, water levels in the first and second heat storage tanks, and temperatures of the heating water in the first and second heat storage tanks.

4. The Organic Rankine Cycle power generation system of claim 3, further comprising a control unit to which pressure data, water level data, and temperature data measured by the sensor unit are transmitted and selectively opens or closes the first high temperature water opening and closing valve, the second high temperature water opening and closing valve, the first cold water opening and closing valve, and the second cold water opening and closing valve to adjust the pressure, the water levels, and the temperatures in the first and second heat storage tanks according to pre-set pressure, water level, and temperature conditions.

5. The Organic Rankine Cycle power generation system of claim 4, further comprising a fixing frame unit that supports and fixes the first and second heat storage tanks, which are spaced apart from each other, from the bottom.

6. The Organic Rankine Cycle power generation system of claim 3, wherein the sensor unit comprises:
a pressure sensor measuring the pressure in the first and second heat storage tanks;
a water level sensor measuring the water levels in the first and second heat storage tanks; and
a temperature sensor measuring the temperatures in the first and second heat storage tanks,
wherein the water level sensor comprises:
an upper water level sensor provided at an upper portion of the first and second heat storage tanks; and
a lower water level sensor provided at a lower portion of the first and second heat storage tanks.

7. The Organic Rankine Cycle power generation system of claim 5, wherein the fixing frame unit comprises:
a pallet member supporting the first and second heat storage tanks from the bottom; and
a fixing member fixing the pallet member and the first and second heat storage tanks in a rectangular shape,
wherein the bottom of the fixing member has a lattice structure.
